(19) United States
(12) Patent Application Publication
(10) Pub. No.: US 2024/0283089 A1
(43) Pub. Date: Aug. 22, 2024

(54) PROTON CONDUCTING RECHARGEABLE BATTERIES AND PROCESSES

(71) Applicant: KAWASAKI MOTORS, LTD., Hyogo (JP)

(72) Inventors: Kwohsiung YOUNG, Hyogo (JP); Shinji SHIIZAKI, Hyogo (JP)

(73) Assignee: KAWASAKI MOTORS, LTD., Hyogo (JP)

(21) Appl. No.: 18/571,897

(22) PCT Filed: Jun. 21, 2021
(86) PCT No.: PCT/JP2021/023413

§ 371 Date: Dec. 19, 2023

(51) Int. Cl. H01M 50/434; H01M 50/403

(52) U.S. Cl. CPC H01M 50/434; H01M 50/403

(57) ABSTRACT

Provided are proton conducting separator materials and rechargeable proton conducing cells that employ the separator materials. The separators include an inorganic ceramic material optionally present as a predominant in the separator. The inorganic ceramic material includes less than 85 weight percent perovskite oxide phase and exhibits a proton conductivity of 0.1 mS/cm or greater at 25 degrees Celsius. Also provide are methods for forming inorganic ceramic materials with improved proton conductivity to allow them to function effectively as a separator in a rechargeable proton conducting cell.

### TECHNICAL FIELD

This disclosure relates to batteries, more specifically rechargeable batteries that cycle protons between the anode and the cathode in the generation of an electrical current that may be used to power one or more devices.

### BACKGROUND ART

Energy storage and efficient recovery of stored energy are increasingly important components of the world energy solutions. Electrochemical storage mechanisms are used throughout various industries such as in electric vehicles, portable computing, and wireless communications. The most common technologies explored to power these systems today are based on lithium ion battery chemistries.

Typical lithium ion batteries cycle using a lithium ion as a charge carrier. The advantages of lithium ions include a high ionization energy and ready abundance leading to acceptable energy density relative to prior systems. Most lithium ion batteries use a graphite anode coupled to a mixed transition metal oxide cathode and employ an electrolyte made from organic carbonate and dissolvable lithium salts. A major drawback of these systems, however, is that the organic solvents are highly flammable thereby risking ignition upon leakage or overcharging situations.

The dangers of traditional lithium ion batteries has caused many to explore the use of solid-state lithium ion batteries that use a non-flammable solid electrolyte with acceptable lithium ion conductivity. Lithium ion solid state batteries in general are highly desirable due to long service life, safe operation by excluding flammable electrolyte materials of prior systems, enabling bi-polar design for yet increased energy density, and case of manufacturing. Thus, the art of solid state batteries typically focuses on lithium ion chemistries for solid state batteries due to the above advantages of lithium ion technologies. While much progress has been made, the lithium ion solid state batteries still employ solid state electrolytes that suffer from poor room temperature conductivity of lithium ions thereby reducing their effectiveness at normal operating temperatures.

As will be explained herein below, the present disclosure addresses these needs by providing new solid state batteries that do not rely on cycling lithium ions. Instead, the cells as provided herein cycle protons using new solid state proton conducting separators that have improved room temperature conductivity thereby solving the issues with lithium ion solid state cells. These and other advantages of the disclosure will be apparent from the drawings, discussion, and description which follow.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole. The inventions as described herein are presented in the claims that follow.

Proton conducting batteries have numerous advantages including fast ion conduction, high energy density, relatively low cost and improved safety profiles relative to lithium ion batteries. Finding ways to effectively incorporate these cell types into a solid state battery design has historically proven difficult. This disclosure provides new materials for efficient and compact solid state batteries.

As such, provided are new materials that can function as a separator in a proton conducting rechargeable cell with improved proton conductivity that thereby addresses several of the shortfalls of prior systems. Provided are proton conducting rechargeable cells that include: a cathode comprising a cathode active material capable of reversibly absorbing a proton; an anode comprising an anode active material capable of reversibly absorbing a proton; and a separator including an inorganic ceramic material present as a predominant in the separator, the inorganic ceramic material including less than 85 weight percent perovskite oxide phase and exhibiting a proton conductivity of 0.1 mS/cm or greater at 25 degrees Celsius. The inorganic ceramic materials optionally include multiple phases, optionally a perovskite oxide phase and a non-perovskite oxide phase that is increased relative to the phase weight percent in a precursor material used to produce the inorganic ceramic material in the separators. In the inorganic ceramic material, the perovskite oxide phase is present at less than 70 weight percent, optionally less than 50 weight percent. In the inorganic ceramic material, the non-perovskite oxide phase is optionally present at 20 weight percent or greater, optionally 30 weight percent or greater. In some aspects, the non-perovskite oxide phase is or includes an ACO₃ phase, wherein A comprises one or more group 2 elements, optionally Ba. The resulting inorganic ceramic materials optionally have a proton conductivity of less than 23 mS/cm.

In some aspects, an inorganic ceramic material includes an oxide, carbonate, hydroxide, or combination thereof of AZrₓY_{y}M_{z}, where A is one or combination of group 2 elements and M is one or combination of transition metals or rare earth metals, 0≤x≤0.8, 0≤y≤0.4, and 0≤z≤0.8. Optionally, x is 0.1 to 0.5. Optionally, y is 0.1 to 0.3. Optionally, M is Ce and z is 0.4 to 0.8. M in the AZrₓY_{y}M, material is optionally La, Ce, Pr, Nd, Sm, Ti, Hf, B, Al, Ga, and combinations thereof.

Also provided are processes of forming an inorganic ceramic material as a proton conducting material for use as a separator in a rechargeable proton conducting cell. A process may include subjecting a precursor material to a humidification process to thereby increase the proton conductivity of the proton conducting material relative to the precursor material. The process includes: preparing a precursor material, the precursor material including one or more group 2 elements; calcining the precursor material at a calcination temperature to form a calcined precursor material; and subjecting said calcined precursor material to a humidification process for a treatment time and at a treatment temperature to provide a proton conducting material. The treatment temperature is optionally from 70 degrees Celsius to 200 degrees Celsius. In some aspects the treatment temperature is increased during the treatment time. A treatment time is optionally 1 hour to 40 hours, optionally 10 hours to 20 hours. The processes optionally provide a proton conducting material that includes less than 85 weight percent perovskite oxide phase and exhibits a proton conductivity of 0.1 mS/cm or greater at 25 degrees Celsius. Optionally, the perovskite oxide phase is present at less than 70 weight percent, optionally less than 50 weight percent.

In the proton conducting material, the perovskite oxide phase may be present at less than 70 weight percent, optionally less than 50 weight percent. In the proton conducting material, the non-perovskite oxide phase is optionally present at 20 weight percent or greater, optionally 30 weight percent or greater. In some aspects, the non-perovskite oxide phase is or includes an ACO₃ phase, wherein A is or includes one or more group 2 elements, optionally Ba. The resulting inorganic ceramic materials optionally have a proton conductivity of less than 23 mS/cm. In some aspects, a proton conducting material includes an oxide, carbonate, hydroxide, or combination thereof of AZrₓY_{y}M_{z}, where A is one or combination of group 2 elements and M is one or combination of transition metals or rare earth metals, 0≤x≤0.8, 0≤y≤0.4, and 0≤z≤0.8. Optionally, x is 0.1 to 0.5. Optionally, y is 0.1 to 0.3. Optionally, M is Ce and z is 0.4 to 0.8. M in the AZrₓY_{y}M_{z} material is optionally La, Ce, Pr, Nd, Sm, Ti, Hf, B, Al, Ga, and combinations thereof.

### BRIEF DESCRIPTION OF DRAWINGS

Various aspects of this disclosure are exemplified in the following drawings which are not limiting on the scope of the invention and wherein:

FIG. 1 illustrates various aspects of solid state separator structures as provided according to some aspects of this disclosure;

FIG. 2 illustrates an XRD pattern of Sample 1 prior to humidification;

FIG. 3 illustrates an XRD pattern of Sample 1 following humidification;

FIG. 4 illustrates an XRD pattern of Sample 2 following humidification; and

FIG. 5 illustrates charge and discharge profiles of Sample 1 used as a separator in a cell.

### DETAILED DESCRIPTION OF VARIOUS ASPECTS

Provided are proton conducting solid state electrolyte materials and methods of production that for the first time provides excellent room temperature charge carrier conductivity. The provided solid state separators and methods of manufacture tailor the chemical composition of the separators to thereby improve room temperature proton conductivity.

As such, provided herein are proton conducting rechargeable cells that include a cathode comprising a cathode active material capable of reversibly absorbing a proton, an anode comprising an anode active material capable of reversibly absorbing a proton, and a proton conducting separator as provided herein. The separators utilize an inorganic ceramic material that may be present as a predominant in the separator. The precursor of the inorganic ceramic material may be a perovskite oxide material, but this precursor perovskite oxide is altered to include less than 85 weight percent perovskite oxide phase. The resulting materials demonstrate a proton conductivity of 0.1 mS/cm or greater at 25 degrees Celsius.

The proton conducting batteries as provided herein operate by cycling a proton between the anode and the cathode. The anodes thereby form a hydride of one or more elements in the anode during charge. This hydride is formed reversibly such that during discharge the hydride becomes the elemental portion of the anode active material generating both a proton and an electron. The half reaction that takes place at the anode can be described per the following half reaction:

M+H⁺+e⁻⇄MH
where M as provided herein is or includes one or more transition or post-transition metals.

The corresponding cathode reaction half reaction is typically:

M_{c}(OH)₂⇄M_{c}OOH+H⁺+e⁻
wherein M_{c} is any suitable metal(s) for use in a cathode electrochemically active material, optionally predominantly Ni or Mn with other metallic substitutes.

The batteries of this disclosure capitalize on this proton conducting chemistry, but further the ability of the cells to function at room temperature by employing separators that include the materials as provided herein.

As used herein, the term “battery” means a collection of two or more cells in series as configured in a solid state battery. A “cell” cell includes a cathode active material, anode active material and a separator as provided herein and functions to reversibly store energy electrochemically.

As used herein, an “anode” includes an electrochemically active material that acts as an electron acceptor during charge.

As used herein, a “cathode” includes an electrochemically active material that acts as an electron donor during charge.

When atomic percentages (at %) are presented and not otherwise defined, the atomic percentages are presented on the basis of the amount of all elements in the described material other than hydrogen and oxygen.

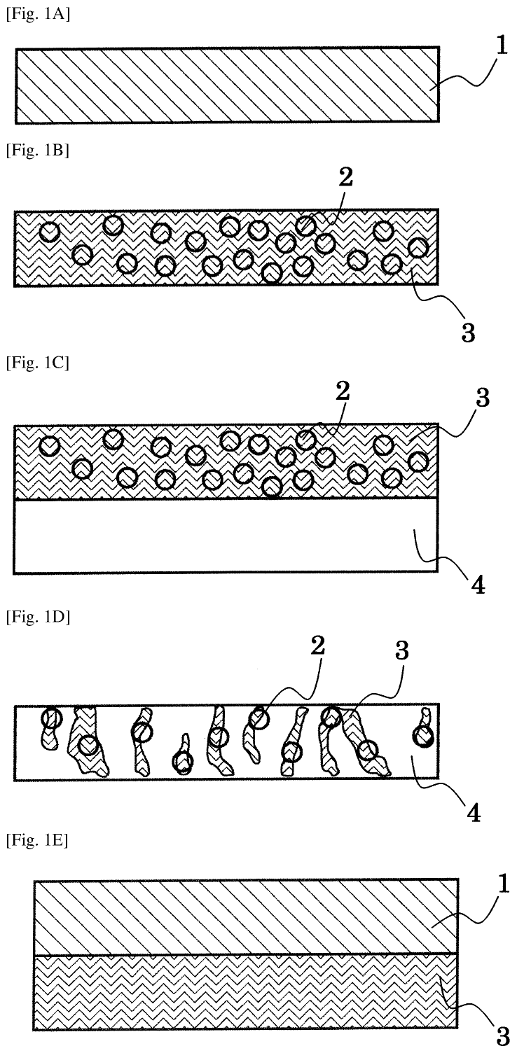

A rechargeable proton conducting cell includes a separator that includes one or more inorganic ceramic materials that may be used alone or associated with an ion exchange membrane. The inorganic ceramic materials may, therefore, be used as a standalone membrane, as a coating on an ion exchange membrane or substrate, embedded within an ion exchange membrane, impregnated within the pores of a porous substrate alone or in conjunction with an ion exchange membrane, or any combination thereof, optionally as illustrated in FIG. 1.

As such, rechargeable proton conducting batteries are provided that include two or more cells, wherein at least one of the cells includes a cathode active material, an anode active material, and a proton conducting separator between the cathode active material and the anode active material. In other aspects, battery as provided herein includes an electrolyte that may be a solid polymer electrolyte, a liquid electrolyte, or any combination thereof where the electrolyte may be housed entirely within the separator, or may be adjacent the separator on one or both sides between the separator and the anode active material and/or the cathode active material.

A rechargeable proton conducting batteries as provided herein includes a proton conducting separator. In some aspects, a separator may be in the form of a proton conducting film. A proton conducting film may be of sufficient film characteristics (e.g. rigidity) to be layered upon or between an anode active material and a cathode active material and provide a suitable thickness to physically and/or electrically separate the anode active material from the cathode active material. The separator in these aspects may be fully formed prior to cell assembly and simply layered with the other elements of the cell in formation thereof.

Illustrative examples of inorganic ceramic materials uses as or a component of a separator include untreated perovskite oxides and/or processed perovskite oxides as provided herein. Perovskite-type oxides have a general formula ABO; with larger A cation coordinated to 12 anions and B cation occupying six coordinate sites, with a phase forming a network of corner sharing BO₆ octahedra. The A cations may be rare-earth, alkali or alkaline earth elements. Typically, the B elements are one or more transition metals or rare earth metals. In some aspects, A may be Ca, Be, Sr, La, Na, K, Mg, or combinations thereof. Optionally, B may be Ce, Zr, Y, Al, Ti, Nb, Ta, Ga, or combinations thereof.

The separator in some aspects may be formed of or include a modified perovskite oxide such that the amount of perovskite oxide phase within the separator is lower than in the precursor perovskite oxide. As such, a precursor perovskite oxide is modified, optionally by one or more processes as provided herein, to form the separator material. As such, a separator may include one or more phases that may be a perovskite oxide and non-perovskite oxide phase. The weight percent of perovskite oxide phase in the precursor can be 60 weight percent (wt %) or more, optionally 70 wt %, 80 wt %, 85 wt %, or higher.

The perovskite oxide phase in the separator material is less than the weight percent of the perovskite oxide phase in the precursor material, optionally as produced using the processes as provided herein. Optionally the weight percent of the perovskite oxide phase in the separator is optionally less than 70 wt %, optionally less than 50 wt % of the total inorganic ceramic material. In some aspects the weight percent of perovskite oxide phase is equal to or less than 85, 80, 75, 70, 65, 60, 55, 50, 45, 40, 35, 30, 25, 20, 15, 10, or less.

In some aspects, the non-perovskite oxide phase that is increased relative to the non-perovskite oxide phase in the precursor material is or includes a carbonate of the A cation(s) of the perovskite oxide as originally used to form the separator material. By subjecting the precursor to a treatment regime to effectively hydrate the materials, at least some and maybe all of the perovskite oxide phase is altered to a carbonate phase of one or more of the A cations of the original perovskite oxide and this configuration dramatically increases the room temperature conductivity of the precursor to thereby be more effective in a proton conducting cell. As such, a separator of invention optionally includes a treated perovskite oxide with less than or equal to 85 weight percent, optionally less than 70 weight percent perovskite oxide phase therein.

The resulting separator optionally has a proton conductivity that is equal to or greater than 0.1 mS/cm at 25 degrees Celsius. In some aspects, the proton conductivity at 25 degrees Celsius is equal to or greater than 0.11 mS/cm, optionally 0.12 mS/cm, optionally 0.13 mS/cm, optionally 0.14 mS/cm, optionally 0.15 mS/cm, optionally 0.16 mS/cm, optionally 0.17 mS/cm, optionally 0.18 mS/cm, optionally 0.19 mS/cm, optionally 0.2 mS/cm, optionally 0.21 mS/cm, optionally 0.22 mS/cm, optionally 0.23 mS/cm, optionally 0.24 mS/cm, optionally 0.25 mS/cm. In some aspects, the proton conductivity of the separation is equal to or less than 23 mS/cm.

An inorganic ceramic material optionally includes one or more group 2 elements. Group 2 elements that may be included in an inorganic ceramic material may be Be, Mg, Ca, Sr, Ba, Ra, or any combination thereof. Optionally, an inorganic ceramic material may include Ba, Mg, or Ca. In other aspects, an inorganic ceramic material may include Ba or Ca. In some aspects, an inorganic ceramic material may include Ba as the sole group 2 element or in combination with one or more other group 2 elements.

As such, a separator as provided herein optionally includes an ACO₃ phase wherein A is the one or more group II elements. Optionally, the inorganic ceramic material includes an ACO₃ phase wherein A may be Be, Mg, Ca, Sr, Ba, Ra, or any combination thereof. Optionally, A in the ACO₃ phase is Ba, Mg, or Ca. In other aspects, A in the ACO₃ phase is Ba or Ca. In some aspects, A in the ACO₃ phase is Ba as the sole group 2 element or in combination with one or more other group 2 elements. The ACO₃ phase may be present in the inorganic ceramic material at 15 weight percent or greater. Optionally, the ACO₃ phase may be present in the inorganic ceramic material at 20 weight percent or greater. Optionally, the ACO₃ phase may be present in the inorganic ceramic material at 30 weight percent or greater. Optionally, the ACO₃ phase may be present in the inorganic ceramic material at a weight percent or greater than 25, 30, 25, 40, 45, 50, 55, 60, 65, 70, 75, 80, or 85.

In some aspects, an inorganic ceramic material is or includes an oxide, carbonate, hydroxide, or combination thereof of AZrₓY_{y}M_{z}, where A is one or combination of group 2 elements and M is one or combination of transition metals or rare earth metals and wherein 0≤x≤0.8, 0≤y≤0.4, and 0≤z≤0.8. The relative amounts of Zr, Y, M and A may be adjusted and still result in a separator with the desired room temperature proton conductivity. For example, x is optionally 0.1 to 0.5 or any value or range therebetween. Optionally y is zero. Optionally, y is 0.1 to 0.3 or any value or range therebetween. When y is greater than zero, a defective perovskite oxide may be formed. In some aspects, the presence of the defective perovskite oxide increases room temperature proton conductivity. Optionally, Z is 0.4 to 0.8 or any value or range therebetween. Optionally, the relative value of A is 1 and the values of x, y and z are normalized to the value of A based on the overall composition of the inorganic ceramic material. For example, in some aspects, A is 1 and x+y+z=1 which is a stoichiometric perovskite oxide. In other examples, A is 1 and x+y+z>1, optionally 1.06. In other examples, A is 1 and x+y+z<1.

In the above formula AZrₓY_{y}M_{z}, where A is one or combination of group 2 elements M may be La, Ce, Pr, Nd, Sm, Ti, Hf, B, Al, Ga, and combinations thereof. In other aspects, M is La, Ce, Ti, Al, or B. In other aspects, M is La, Ce or Ti. Optionally, M is Ce optionally at the exclusion of other elements. In some aspects, M is Ce and z is 0.4 to 0.8 or any value or range therebetween. In some aspects, M is Ce and A is Be.

A processed perovskite oxide may be a product of chemically modified perovskite oxide formed through certain process, such as the processes as provided herein. A chemically modified perovskite oxide is optionally chemically modified by humidification so as to reduce the amount of perovskite oxide phase to 85 weight percent or less, and/or to produce an or an increased weight percent of an ACO₃ phase as described herein, optionally present at 15 weight percent or greater.

A modified perovskite oxide is optionally humidified thereby producing a weight gain to the material relative to the precursor. Optionally, a weight gain is greater than zero. Optionally, the weight gain of the modified perovskite oxide is equal to or greater than 5 weight percent. In some aspects, the weight gain percent in the modified perovskite oxide is equal to or greater than 5, 6, 7, 8, 9, 10, 11, 12, 13, 14, 15, 16, 17, 18, 19, or 20. Optionally, the weight gain percentage of the modified perovskite oxide is greater than or equal to 20.

The inorganic ceramic material may be produced by a sol-gel process as known in the art. For example the desired salts necessary for forming the material may be combined in water with an acid, tryelthylenetetraamine optionally a described by Osman et al., Advanced Materials Research, 2014; 896:112-115. The resulting material may be dried, optionally at 100 degrees Celsius for sufficient time to remove all fluid from the materials.

The modified inorganic ceramic material may be formed by first calcining the inorganic ceramic material at a calcination temperature to form a calcined precursor material, and then subjecting the calcined precursor material to a humidification process for a treatment time and at a treatment temperature to provide a proton conducting material, optionally with a proton conductivity of equal to or greater than 0.1 mS/cm at 25 degrees Celsius. The humidification process is optionally performed in an atmosphere that includes water. Water is optionally present in the atmosphere as water vapor in a gas, optionally saturated water vapor in a gas. The gas may be any inert gas, optionally air, nitrogen, argon or other desired gas. The relative humidity of the atmosphere is optionally 80 percent or greater, optionally 90 percent or greater, optionally 99 percent or greater, optionally 100 percent (i.e. saturated).

The calcined precursor material is optionally subjected to the humidification process at a treatment time at a treatment temperature. A treatment time and/or treatment temperature is optionally any time sufficient to produce a proton conducting material with a weight at or above the weight of the precursor material and/or to produce the desired amount of perovskite oxide phase therein, optionally equal to or less than 85 weight percent perovskite oxide phase.

Optionally, the treatment time and/or treatment temperature is sufficient to produce a proton conducting material with a proton conductivity of 0.1 mS/cm or greater at 25 degrees Celsius. In some aspects, the treatment time is sufficient to produce a proton conducting material with a proton conductivity at 25 degrees Celsius is equal to or greater than 0.11 mS/cm, optionally 0.12 mS/cm, optionally 0.13 mS/cm, optionally 0.14 mS/cm, optionally 0.15 mS/cm, optionally 0.16 mS/cm, optionally 0.17 mS/cm, optionally 0.18 mS/cm, optionally 0.19 mS/cm, optionally 0.2 mS/cm, optionally 0.21 mS/cm, optionally 0.22 mS/cm, optionally 0.23 mS/cm, optionally 0.24 mS/cm, optionally 0.25 mS/cm. In some aspects, the proton conductivity of the separation is equal to or less than 23 mS/cm.

In some aspects, a treatment time and/or treatment temperature is sufficient to produce a proton conducting material with a weight gain of a desired amount or greater. Optionally, the treatment time and/or treatment temperature is sufficient to produce a proton conducting material exhibiting a weight gain percentage that is greater than zero. Optionally, the weight gain of the proton conducting material relative to the precursor material is equal to or greater than 5 weight percent. In some aspects, the weight gain percentage in the proton conducting material is equal to or greater than 5, 6, 7, 8, 9, 10, 11, 12, 13, 14, 15, 16, 17, 18, 19, or 20. Optionally, the weight gain percentage of the modified perovskite oxide is greater than or equal to 20.

In some aspects, a treatment time and/or treatment temperature is sufficient to produce a proton conducting material with less than 85 weight percent perovskite oxide phase. Optionally, the treatment time and/or treatment temperature is sufficient to produce a proton conducting material with equal to or less than 85, 80, 75, 70, 65, 60, 55, 50, 45, 40, 35, 30, 25, 20, 15, 10, or less perovskite oxide phase.

In some aspects, a treatment time and/or treatment temperature is sufficient to produce a proton conducting material with greater than or equal to 20 weight percent ACO₃ phase. Optionally, the treatment time and/or treatment temperature is sufficient to produce a proton conducting material with ACO₃ phase at a weight percent or greater than 25, 30, 25, 40, 45, 50, 55, 60, 65, 70, 75, 80, or 85.

A treatment temperature is optionally from 70 degrees Celsius to 200 degrees Celsius, or any value or range therebetween. In some aspects, a treatment temperature is at or greater than 75 degrees Celsius, optionally 80 degrees Celsius, optionally 85 degrees Celsius, optionally 90 degrees Celsius, optionally 95 degrees Celsius, optionally 100 degrees Celsius, optionally 125 degrees Celsius, optionally 150 degrees Celsius, optionally 175 degrees Celsius, optionally 200 degrees Celsius.

Optionally, a treatment temperature is not constant over the treatment time. The treatment temperature may be increased or decreased over the treatment time so as to tailor the resulting weight gain and/or saturation in the material in the material following treatment.

A treatment time is optionally from 1 hour to 40 hours or any value or range therebetween. Optionally, a treatment time is from 5 hours to 30 hours, optionally 10 hours to 20 hours, optionally 15 hours to 17 hours. In some aspects, a treatment time is at or greater than 1, 2, 3, 5, 7, 10, 15, 20, 25, 30, 35, or 40 hours.

Treatment time is optionally from 1 hour to 40 hours, optionally 10 hours to 20 hours and a treatment temperature is from 70 degrees Celsius to 200 degrees Celsius, or any value or range therebetween. Optionally a treatment time is In some aspects, a treatment time is at or greater than 1, 2, 3, 5, 7, 10, 15, 20, 25, 30, 35, or 40 hours and a treatment temperature is 5 hours to 30 hours, optionally 10 hours to 20 hours, optionally 15 hours to 17 hours, optionally at or greater than 1, 2, 3, 5, 7, 10, 15, 20, 25, 30, 35, or 40 hours.

The resulting processing of inorganic ceramic materials allows for the formation of a separator with the inorganic ceramic material optionally as a predominant in the separator and with less than 85 weight percent perovskite oxide phase and/or exhibiting a proton conductivity of 0.1 mS/cm or greater at 25 degrees Celsius. The inorganic ceramic material may be used as a separator material alone or may be used in conjunction with a substrate and/or an ion conducting polymer. The separators are located between the anode and the cathode in one or more of the cells in a battery as provided herein. The separator may completely separate the cathode active material from the anode active material in each cell. The edges of the separator may contact peripheral edges of a current collector plate where the plate does not have an anode active material or cathode active material disposed thereupon so as to completely separate the anode active material from the cathode active material. The separator functions to prevent short circuiting of the cells due to dendrite formation; functions to allow liquid electrolyte if present, protons, electrons or any combination of these elements to pass through it, optionally selectively pass through or be conducted by the separator.

The separator may be include in addition to the inorganic ceramic material a nonelectrically conductive material, such as polymer films optionally porous polymer films, glass mats, porous rubbers, ionically conductive gels or natural materials, and the like. Among exemplary materials useful as separators are porous or non-porous high or ultra-high molecular weight polyolefin materials that serve as a base or as the ion conductive polymer in the separator.

The separator may be in the form of an proton conducting membrane such as a rigid or flexible sheet of inorganic ceramic material 1 that may serve as a standalone system for the transfer of protons between a cathode and anode of a cell is optionally as illustrated in FIG. 1A. In some aspects, a plurality of particles of inorganic ceramic material 2 may be associated with, optionally embedded in or on an ion conducting polymer 3 (ICP, optionally selective for protons) in the form of a sheet or film as illustrated in FIG. 1B. Optionally, an separator may be an inorganic ceramic material associated with a proton conducting solid support 4 as a component of an ion conducting polymer optionally as illustrated in FIG. 1C, whereby the term “solid” with respect to a support as provided herein means that the support will not transmit ICP through the support during operation of the cell. In other aspects, a support 4 may be porous and may house within the pores particles of an inorganic ceramic material 2 alone or with an ion conducting polymer substantially as illustrated in FIG. 1D. The ion conducting polymer 3 in the form of a sheet may be layered on, coated on or otherwise placed in direct contact with a layer of inorganic ceramic material 1 as illustrated in FIG. 1E.

In some aspects, a separator may include a porous substrate that contains pores or tortuous paths through the separator that allows electrolyte, protons, electrons or a combination thereof to pass through the separator, optionally as illustrated in FIG. 1D. The pores of the substrate may be filled with one or more ICPs to form the resulting separator. Such highly porous substrate materials may be made from known porous ceramic or polymer materials. The ICP may be housed within the pores so as to form a conductive path for ions to flow or be conducted through the separator material. In some aspects, a porous separator material is further coated on one or both sides with a sheet or film of ICP in formation of the separator as a whole. Optionally, an ICP may be coated on an electrically insulating material such as polypropylene that serves as a structural aspect of a separator.

A porous substrate optionally has a porosity defined as the ratio of pore volume (i.e. void volume) to total volume of the porous substrate and may be measured by any of known methods in the art, illustratively mercury intrusion, gas adsorption, or a capillary flow method based on fluid flow through the membrane such as achieved by a capillary flow porometer. A porosity is optionally equal to or greater than 20%, optionally 30%, optionally 40%, optionally 50%, optionally 60%, optionally 70%, optionally 80%. In some aspects, a porosity is at or between 20% and 80%, optionally 30% and 60%, optionally 40% and 50%.

A separator as provided herein optionally includes an ion conducting polymer in addition to an inorganic ceramic material. Illustrative examples of ion conducting polymers include those that conduct, optionally selectively conduct, a proton, yet are electrically insulating. An electrical resistivity of a separator used in a cell as provided herein is at or less than 1×10⁻⁴ ohm·m², optionally 8×10⁻⁵ ohm·m² or less, optionally 6×10⁻⁵ ohm·m² or less, optionally 4×10⁻⁵ ohm·m² or less, optionally 3×10⁻⁵ ohm·m² or less.

A proton conducting material suitable for use as an ICP in a separator include but are not limited to hydrated acidic polymers that may include interpenetrating hydrophobic and hydrophilic domains where the hydrophobic domains may provide the structural dimension of the polymer whereas the hydrophilic domains allow for selective proton conduction. Illustrative examples of such polymers include those formed of poly(styrenesulfonate). Other illustrative examples of proton conducting materials include perflourinated polymers such as but not limited to perfluorosulfonic acid (PFSA) polymers such as NAFFION. In some aspects, a polymer is a polyaromatic polymer that is electrically insulating but conductive of protons. In yet further aspects, a proton conducting polymer is a composite material where proton conducting materials are embedded within or adhered to a polymer matrix that is optionally nonproton conducting.

A proton conducting polymer optionally is electrically insulating but conductive of protons. Proton conductivity is optionally at or greater than 0.1 mS/cm when measured at room temperature, optionally 0.2 mS/cm or greater, optionally 1 mS/cm or greater.

A separator may include one or more ion conducting polymers and/or inorganic ceramic materials impregnated within or onto an ion conducting substrate. Illustrative examples of ion conducting substrates include those formed of one or more transition metals, or oxides, hydroxides, or oxyhydroxides thereof. Illustrative examples include but are not limited to Pt, Pd, LaNi₅. Alternatively or in addition, an ion conducting polymer for use in a separator may include an oxide such as a metal oxide (e.g. ZrO₂, CeO₂, TiO₂) or perovskite oxide as otherwise described herein.

A separator may be provided in the form of a membrane or a film and simply stacked between the anode active material and cathode active material, or may be coated onto an anode active material, cathode active material or both. Forming an ion conducting polymer separator may be achieved by general polymerization methods as known in the art, illustratively free radical polymerization, from the desired precursor materials An ion conducting polymer layer may optionally be coated onto a desired electrode surface such as by polymerizing the material in the presence of an on the surface of the desired electrode. The precursor materials may combined with a solvent and coated onto the electrode material. The solvent that is used for the polymerization reaction of the polymer is not particularly limited. Illustratively, a solvent may be hydrocarbon-based solvents (methanol, ethanol, isopropyl alcohol, toluene, heptane, and xylene), ester-based solvents (ethyl acetate and propylene glycol monomethyl ether acetate), ether-based solvents (tetrahydrofuran, dioxane, and 1,2-diethoxyethane), ketone-based solvents (acetone, methyl ethyl ketone, and cyclohexanone), nitrile-based solvents (acetonitrile, propionitrile, butyronitrile, and isobutyronitrile), halogen-based solvents (dichloromethane and chloroform), and the like. As an example, one or more ion conducting polymer separator precursor materials may be combined with a solvent on the surface of an electrode, optionally retained by a structure of the electrode itself, a container in which the electrode is placed into or other retention system, and the precursor materials allowed to dry or polymerize on the surface of the electrode to thereby form a layer thereon at the desired size and thickness.

A separator as provided herein has a thickness. A thickness should be sufficient so that the desired electrical resistance is achieved as well as physical separation of the anode from the cathode, but also not so thick that efficient transport of a proton through the separator is undesirably inhibited. Illustratively, a separator has thickness of 1 micron to 100 microns or more. Optionally, a separator thickness is 1 micron to 50 microns, optionally 10 micron to 30 microns, optionally 20 microns to 30 microns.

An anode, cathode, or both include electrochemically active material coated onto a current collector substrate. Coating may be achieved by coating the metal substrate with a layer of the electrode active material in the presence of a solvent. An exemplary solvent that is commonly used is N-Methyl-2-pyrrolidone (NMP). A binder, which by example only may be poly vinylidene fluoride (PVDF), may also be included. After the coating of the electrode material has been applied to the substrate, the coating may be dried such as by heating, subjecting to ambient atmosphere, subjected to microwave energy or other energy. The material may optionally be subjected to a calendaring process to press and heat the coating, which increases the density of the coating. Adhesion between a coating and a substrate is usually achieved through surface roughness, chemical bonding, and/or interface reaction or compound.

The respective electrode active material may be combined with a support substrate such as a cathode substrate or an anode substrate depending on whether an anode active material or cathode active material is being utilized in the particular structure. The presence of the support substrate allows for a more robust cathode or anode structure that may be individually stacked optionally with a bipolar plate (depending on battery design), current collector substrate, and separator for rapid manufacture. An exemplary substrate for an anode or a cathode is steel such as stainless steel, nickel-plated steel, aluminum optionally an aluminum alloy, nickel or nickel alloy, copper or copper alloys, polymers, glass, or other material that suitably may conduct or transmit desired ions and electrons, or other such material. The substrate(s) may be in the form of a sheet optionally as a foil, solid substrate, porous substrate, grid, foam or foam coated with one or more metals, perforated metallic material such as perforated nickel-plated stainless steel or the like, or other form. In some aspects, an anode substrate, cathode substrate or both is in the form of a foil. Optionally, a grid may include expanded metal grids and perforated foil grids. It is not necessary that an anode substrate, cathode substrate, or both be in direct contact with a bipolar metallic plate or current collector substrate, but may be housed within the respective electrode active material. In some aspects, however, an anode substrate, cathode substrate, or both are in electrical contact, optionally direct electrical contact with a bipolar metallic plate and/or current collector substrate.

An anode active material as used in a proton conducting rechargeable cell as provided herein optionally includes one or more hydrogen storage materials. Illustrative examples of such materials are the ABₓ class of hydrogen storage materials where A is a hydride forming element, B is a non-hydride forming element and x is from 1-5. Illustrative examples include the AB, AB₂, AB₃, A₂B₇, A₅B₁₉, and AB₅ type materials as they are known in the art. A hydride forming metal component (A) optionally includes but is not limited to titanium, zirconium, vanadium, hafnium, lanthanum, cerium, prascodymium, neodymium, promethium, samarium, yttrium, or combinations thereof or other metal(s) such as a mischmetal. A B (non-hydride forming) component optionally includes a metal selected from the group of aluminum, chromium, manganese, iron, nickel, cobalt, copper, and tin, or combinations thereof. In some aspects, AB, type materials that may be further included in an anode electrochemically active material are disclosed, for example, in U.S. Pat. Nos. 5,536,591 and 6,210,498. Optionally, non-group 14 element containing hydrogen storage materials are as described in Young, et al., International Journal of Hydrogen Energy, 2014; 39(36):21489-21499 or Young, et al., Int. J. Hydrogen Energy, 2012; 37:9882. Optionally, anode active materials are as described in U.S. Patent Application Publication No: 2016/0118654. In some aspects, an anode active material includes hydroxides, oxides, or oxyhydroxides of Ni, Co, Al, Mn, or combinations thereof, optionally as described in U.S. Pat. No. 9,502,715. Optionally, an anode active material includes a transition metal such as Ti, V, Cr, Mn, Fc, Co, Ni, Cu, Zn, Ag, Au, Cd, or combinations thereof, optionally as disclosed in U.S. Pat. No. 9,859,531. In some aspects, an anode active material is or includes one or more Group 4 elements, optionally Si, Ge, C, or any combination thereof.

The anode active material may be presented in a powder form, meaning that the anode electrochemically active material is a solid at 25 degrees Celsius)(° ° C. and free of any substrate. The powder may be held together by a binder that associates the powder particles in a layer that is coated onto or into a substrate, a biopolar metallic plate, or a current collector substrate in the formation of an anode.

A proton conducting rechargeable cell as provided herein also includes a cathode that includes a cathode active material. A cathode active material has the capability to absorb and desorb a hydrogen ion in the cycling of a battery so that the cathode active material functions in pair with the anode active material to produce an electrical current. Illustrative materials suitable for use in a cathode active material include metal hydroxides. Illustrative examples of metal hydroxides that may be used in a cathode active material include those described in U.S. Pat. Nos. 5,348,822; 5,637,423; 5,366,831; 5,451,475; 5,455,125; 5,466,543; 5,498,403; 5,489,314; 5,506,070; 5,571,636; 6,177,213; and 6,228,535.

In some aspects, a cathode active material includes a hydroxide of Ni alone or in combination with one or more additional metals. Optionally, a cathode active material includes Ni and 1, 2, 3, 4, 5, 6, 7, 8, 9, or more additional metals. Optionally, a cathode active material include Ni as the sole metal.

Optionally, a cathode active material includes one or more metals selected from the group of Sc, Ti, V, Cr, Mn, Fc, Co, Ni, Cu, Zn, Y, Zr, Nb, Mo, Tc, Ru, Rh, Pd, Ag, Cd, Lu, Hf, Ta, W, Rc, Os, Ir, Pt, Au, a hydride thereof, an oxide thereof, a hydroxide thereof, an oxyhydroxide thereof, or any combination of the foregoing. Optionally, a cathode active material includes one or more of Ni, Co, Mn, Zn, Al, Zr, Mo, Mn, a rare earth, or combinations thereof. In some aspects, a cathode active material includes Ni, Co, Al, or combinations thereof.

A cathode active material may include Ni. Ni is optionally present at an atomic percentage relative to the total metals in the cathode active material of 10 atomic percent (at %) or greater. Optionally, Ni is present at 15 at % or greater, optionally 20 at % or greater, optionally 25 at % or greater, optionally 30 at % or greater, optionally 35 at % or greater, optionally 40 at % or greater, optionally 45 at % or greater, optionally 50 at % or greater, optionally 55 at % or greater, optionally 60 at % or greater, optionally 65 at % or greater, optionally 70 at % or greater, optionally 75 at % or greater, optionally 80 at % or greater, optionally 85 at % or greater, optionally 90 at % or greater, optionally 91 at % or greater, optionally 92 at % or greater, optionally 93 at % or greater, optionally 94 at % or greater, optionally 95 at % or greater, optionally 96 at % or greater, optionally 97 at % or greater, optionally 98 at % or greater, optionally 99 at % or greater. Optionally the sole metal in the cathode electrochemically active material is Ni.

An anode active material, a cathode active material, or both are optionally in a powder or particulate form. The particles may be held together by a binder to form a layer on a current collector in the formation of the anode or cathode. A binder suitable for use in forming an anode, a cathode or both is optionally any binder known in the art suitable for such purposes and for the conduction of a proton.

Illustratively, a binder for use in the formation of an anode, a cathode, or both includes but is not limited to polymeric binder materials. Optionally a binder material is an elastomeric material, optionally styrene-butadiene (SB), styrene-butadiene-styrene block copolymer (SBS), styrene-isoprene-styrene block copolymer (SIS) and styrene-ethylene-butadiene-styrene block copolymer (SEBS). Illustrative specific examples of a binder include, but are not limited to polytetrfluoroethylene (PTFE), polyvinyl alcohol (PVA), teflonized acetylene black (TAB-2), styrene-butadiene binder materials, or/and carboxymethyl cellulose (CMC). Illustrative examples may be found in U.S. Pat. No. 10,522,827. The ratio of electrochemically active material to binder is optionally from 4:1 to 1:4. Optionally, the ratio of electrochemically active material to binder is 1:3 to 1:2.

A cathode, anode or both may further include one or more additives intermixed with the active materials. An additive is optionally a conductive material. A conductive material is optimally a conductive carbon. Illustrative examples of a conductive carbon include graphite. Other examples are materials that contain graphitic carbons, such as graphitized cokes. Still other examples of possible carbon materials include non-graphitic carbons that may be amorphous, non-crystalline, and disordered, such as petroleum cokes and carbon black. A conductive material is optionally present in an anode or a cathode at a weight percent (wt %) of 0.1 wt % to 20 wt %, or any value or range therebetween.

An anode or a cathode may be formed by any method known in the art. For example, an anode electrochemically active material or a cathode electrochemically active material may be combined with a binder, and optionally conductive material, in an appropriate solvent to form a slurry. The slurry may be coated onto a bipolar metal plate, current collector substrate or electrode support and dried to evaporate some or all of the solvent to thereby form an electrochemically active layer.

While in some aspects, a separator as provided herein may function as both a separator and electrolyte due to the ability of the separator to conduct a proton or hydroxyl ion and provide the required electrical insulating characteristics to serve a separator between the anode and the cathode, it is appreciated that in some aspects a proton conducting rechargeable cell may further include a separate electrolyte, optionally a liquid or solid polymer electrolyte. An electrolyte may be impregnated into a separator, or may be adjacent to the separator on one or both sides between the separator and the adjacent electrode.

An electrolyte may be any proton conducting electrolyte. Optionally, an electrolyte is an organic or inorganic acid solution, a solid polymer electrolyte, or some combination thereof.

Optionally, an electrolyte is optionally solid polymer electrolyte. A solid polymer electrolyte may include a polymeric material such as poly(ethylene oxide), poly(vinyl alcohol), poly(acrylic acid), or a copolymer of epichlorohydrin and ethylene oxide, optionally with one or more hydroxides of potassium, sodium, calcium, lithium, or any combination thereof.

An electrolyte may optionally be or include one or more organic solutions. Illustrative examples of an organic electrolyte material include ethylene carbonate (EC), propylene carbonate (PC), dimethyl sulfoxide (DMSO), dimethylformamide (DMF), or polyvinyl alcohol (PVA) with added acid, proton conductive ionic liquids as known in the art. Illustrative examples of a proton conductive ionic liquids may include, but are not limited to those that include acetates, sulfonates, or borates of 1-butyl-3-methylimidazolium (BMIM), 1-ethyl-3-methylimidazolium (EMIM), 1,3-dimethylimdiazolium, 1-ethyl-3-methylimidazolium, 1,2,3-trimethylimidazolium, tris-(hydroxyethyl)methylammonium, 1,2,4-trimethylpyrazolium, or combinations thereof. Specific examples include diethylmethylammonium trifluoromethanesulfonate (DEMA TfO), 1-ethyl-3-methylimidazolium acetate (EMIM Ac) or 1-butyl-3-methylimidazolium bis(trifluoromethylsulfonyl)imide (BMIM TFSI).

The stack of cells are optionally flanked on each end by a current collector substrate. A current collector substrate may be formed of any material that has suitable conductivity to transmit electrons from an associated cell to an external environment. A current collector substrate may be formed of steel such as stainless steel, nickel-plated steel, aluminum optionally an aluminum alloy, nickel or nickel alloy, copper or copper alloys, or other such material. For an anti-corrosion property in acid electrolyte, a current collector substrate may be formed of stainless steel. Optionally, both the current collector substrates at the anode of a cell stack and the cathode end of the cell stack are formed of nickel plated stainless steel.

A current collector is optionally in the form of a sheet, and may be in the form of a foil, solid substrate, porous substrate, grid, foam or foam coated with one or more metals, or other form known in the art. In some aspects, a current collector is in the form of a foil. Optionally, a grid may include expanded metal grids and perforated foil grids.

The current collector or substrates may include one or more tabs to allow the transfer of electrons from the current collector to a region exterior of the cell and to connect the current collector(s) to a circuit so that the electrons produced during discharge of the cell may be used to power one or more devices. A tab may be formed of any suitable conductive material (e.g. Ni, Al, or other metal) and may be welded onto the current collector. Optionally, each electrode has a single tab.

One or more cells of a battery may be housed in a cell case (e.g. housing). The housing may be in the form of a metal or polymeric can, or can be a laminate film, such as a heat-scalable aluminum foil, such as an aluminum coated polypropylene film. As such, a cell or battery as provided herein may be in any known cell form, illustratively, a button cell, pouch cell, cylindrical cell, or other suitable configuration. In some aspects, a housing in is in the form of a flexible film, optionally a polypropylene film. Such housings are commonly used to form a pouch cell. The proton conducting battery may have any suitable configuration or shape, and may be cylindrical or prismatic.

A battery optionally is a bipolar battery and includes two or more proton conducting cells as provided herein whereby at least two of the cells are separated by a bipolar metallic plate and at each end of the stack exists a current collector substrate. A bipolar battery may have 2 or more cells, optionally 3 or more cells, optionally 4, 5, 6, 7, 8, 9, 10 or more cells in a stack arrangement.

Various aspects of the present disclosure are illustrated by the following non-limiting examples. The examples are for illustrative purposes and are not a limitation on any practice of the present invention. It will be understood that variations and modifications can be made without departing from the spirit and scope of the invention.

### EXPERIMENTAL

Six samples of modified inorganic ceramic material of various composition were formed under differing synthetic conditions. The compositions were formed as oxides of BaCeZrY. The following six samples and a control were created wherein d is presented to satisfy the remaining elements:
Sample 1: BaCe_{0.6}Zr_{0.26}Y_{0.2}O_{3-δ} formed without Brij O10 sintered at 1100° C.;
Sample 2: BaCe_{0.6}Zr_{0.26}Y_{0.2}O_{3-δ} formed with Brij O10 sintered at 1100° C.;
Sample 3: BaCe_{0.5}Zr_{0.3}Y_{0.2}O_{3-δ} formed with Brij O10 sintered at 950° C.;
Sample 4: BaCe_{0.5}Zr_{0.3}Y_{0.2}O_{3-δ} formed with Brij O10 sintered at 1100° C.;
Sample 5: BaCe_{0.3}Zr_{0.5}Y_{0.2}O_{3-δ} formed with Brij O10 sintered at 950° C.;
Sample 6: BaCe_{0.3}Zr_{0.5}Y_{0.2}O_{3-δ} formed with Brij O10 sintered at 1100° C.; and
Sample 7: BaCO₃ powder (compositional control).

In the off-stoichiometric example of Sample 2, δ is −0.02. In the stoichiometric example of Sample 3, δ is 0.1. The value of δ is readily determined using ordinary techniques. The samples were formed by a sol-gel method using the reagents and amounts as illustrated in Table 1.

TABLE 1

| | | | | | | | Samples 3 | Samples 5 |
|---|---|---|---|---|---|---|---|---|
| | | Sample 1 | | Sample 2 | | | and 4 | and 6 |
| | | Measure | Water | Measure | | Water | Measure | Measure |
| Solution | Name | amount g | amount ml | amount g | | amount ml | amount g | amount g |
| 1 | Ba(NO₃)₂ | 10 | 140 | 5 | | 140 | 2 | 2 |
| 2 | Ce(NO₃)₃•6H₂O | 9.97 | 20 | 4.99 | | 20 | 1.67 | 1 |
| 3 | Zr(NO₃)₂O•2H₂O | 2.65 | 40 | 1.33 | | 40 | 0.61 | 1 |
| 4 | Y(NO₃)₃•4H₂O | 2.66 | 20 | 1.33 | | 20 | 0.53 | 0.53 |
| 5 | Citric acid | 29.4 | 80 | 10 | | 80 | 5.9 | 5.9 |
| 6 | TETA | 22.38 | 80 | 8 | | 80 | 0 | 0 |
| 7 | Ethylene Glycol | 40 ml | 60 | 30 | ml | 60 | 122 | 205 |
| 8 | Brij O10 | | | 2.5 | ml | 30 ml | 1.8 | 1.8 |

ethylene
glycol

Sample 1 was formed by dissolving the salts, citric acid, and TETA individually in water according to the desired amounts as shown in Table 1. The clear solutions 1-4 were then intermixed. Solution 5 was slowly pumped into solution 6 at a speed of about 1.5 milliliters (ml)/minute (min) with stirring around 200 revolutions per minute (rpm). When the temperature of the resulting combined solution of 5 and 6 was decreased to 40° C., it was slowly pumped into the salt solution with a mixing speed of approximately 1.5 ml/min. Solution 7 (ethylene glycol) was then pumped into the salt containing solution. Finally solution 8 was pumped into the salt solution. The overall mixture was heated to 85-100° C. for one hour with stirring. Following the initial heating, the heat of the solution was raised at a rate of 20° C. every 15 minutes until reaching a final temperature of 150° ° C. The solution formed a clear-yellow gel, upon which heating was ceased. The gel was then moved to an oven at 100° C. and dried for 20 hours. The resulting product was calcined at a temperature rate increase of 10° C./min to 325° C., with a hold at 325° C. for 2 hr, then further increased at 10° C./min to 1100° ° C. with a second hold at 1100° C. for 10 hours (hr). The particle size following calcination of Sample 1 was about 10 micrometers.
Sample 2 was formed by an identical process to Sample 1, with the exception that the formation was performed in the presence of the surfactant Brij O10 at the amount specified in Table 1. It was found that particle morphology in the presence of Brij O10 showed greater uniformity than with other surfactants such as sodium dodecyl sulfonate (SDS).
Sample 3 was formed by dissolving the nitrate salts and citric acid in ethylene glycol in a beaker. After the reagents were fully dissolved, the Brij O10 was added and the solution heated with a rate increase of 2ºC/min on the heating plate with magnetic stirring, and then kept at 180-200° C. until vapor was no longer observed. The resulting slurry was then calcined with a rate increase of 10° C./min to 325° C. with a hold at 325° C. for 2 hr, then the heat increased at 10° C./min to 950° C. followed by a second hold at the temperature for 10 hr. The product was naturally cooled to room temperature and then crushed into average 10 microns particle size (average diameter) as measured by scanning electron microscopy.
Sample 4 was prepared the same as sample 3, but sintering was continued and held at 1100° C.
Sample 5 was prepared identically to sample 3, with the exception of the desired amounts of the Ce and Zr salts used.
Sample 6 was prepared the same as sample 5, but sintering was continued and held at 1100° C.

The compositions of samples 1-7 where either subjected to humidification or as a control not humidified. Humidification was performed by placing the particulate materials in air with saturated water vapor at 70° C. for 16 hours. The resulting humidified material was then dried until the water content was determined at 20 wt % with the water content calculated by weight increase of the material relative to weight prior to humidification.

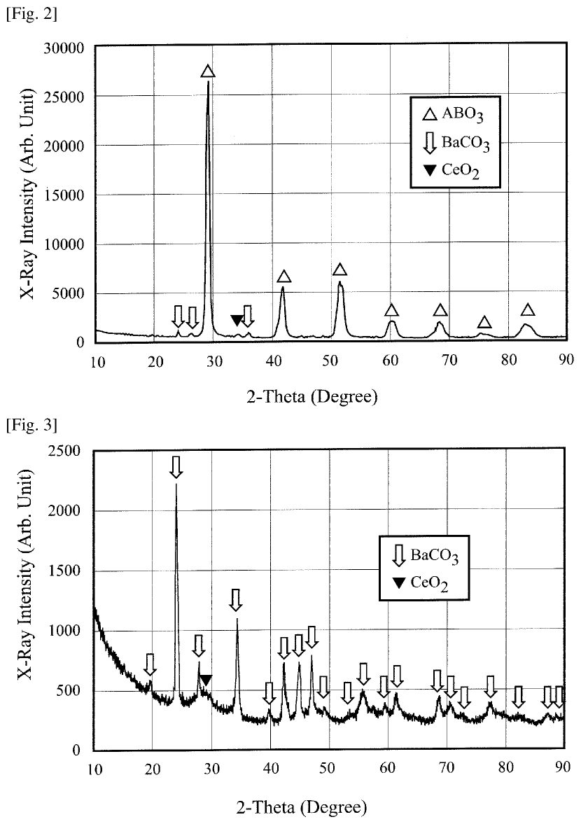

The resulting materials were then analyzed by x-ray diffraction (XRD) utilizing a Bruker D2 PHASER x-ray diffractometer with Cu-K_{α} as radiation source for various phase structures resulting from the synthetic and treatment steps or controls. The XRD spectra of the non-humidified control sample are illustrated in FIG. 2 demonstrating the presence of a mixture of ABO₃ phase structure along with a small amount of BaCO₃ and CeO₂ phase structures. The relative abundance of these phases in the control of Sample 1 was calculated at 5.3 wt % BaCO₃, 2.1 wt % CeO₂, and 92.6 wt % ABO₃.

As illustrated in FIG. 3, following humidification the phase structure of the sample was altered to decrease the ABO; phase abundance. The relative phase abundance of Sample 1 following humidification was 78 wt % BaCO₃, 22 wt % CeO₂ with the remaining being ABO₃ phase.

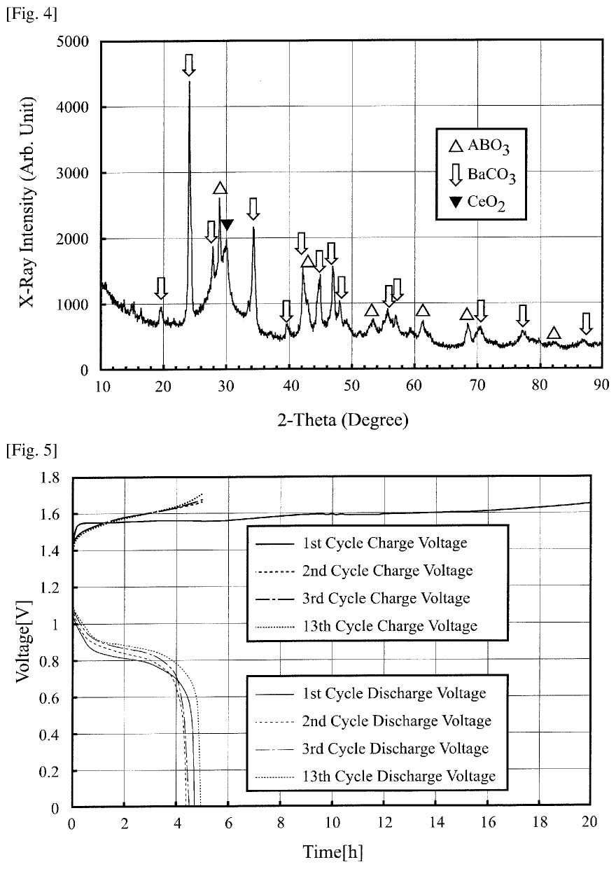

Similar to humidification of Sample 1, when sample 2 was subjected to humidification the XRD pattern (FIG. 4) revealed low ABO; phase abundance of 7 wt % also with high BaCO; (44 wt %) and CeO₂ (49 wt %) phase abundances.

The various humidified samples and controls were subjected to proton conductivity measurements. Each sample powder was put into a 6 millimeter (mm) inner diameter tube and pressed about 0.5 mm thickness with a press of 160 MPa to form a separator. A sintered Ni(OH)₂ cathode (0.5 mm thick) and a Pd foil (12.5 μm thick) anode were placed onto respective opposing sides of the separator with a steel current collector at each end. The steel current collector was switched to a stainless steel current collector after first 10 cycles to avoid the potential corrosion of the steel current collector. Overall, the cell capacity of the design was about 20:1 (cathode to anode). The resulting cell was subjected charge and discharge rates calculated by the capacity of the Pd foil with a first charge at C/5 rate for 20 hours then discharge to 0 V cutoff voltage. Subsequently, the cell was charged with a C/5 rate for 5 hours and discharge measured at C/5, C2 and IC rates. The resulting difference in the discharge voltages versus discharge current density was used to calculate the proton conductivity of the solid separator.

The various curves for Sample 1 following humidification are presented in FIG. 5. Following the first formation cycle for the positive electrode, the charge voltages are nearly the same for the remaining tested cycles. The coulomb efficiency first decreased then increased to nearly 100%. The conductivity of the cell which was dominated by it from the separator at various cycles are illustrated in Table 2.

TABLE 2

| Cycle # | Current collector | Conductivity of cell (mS/cm) |
|---|---|---|
| 4 | SKH51 | 0.2 |
| 6 | SKH51 | 0.2 |
| 9 | SKH51 | 0.21 |
| 10 | SKH51 | 0.2 |
| 12 | SUS316 | 0.17 |
| 21 | SUS316 | 0.17 |
| 28 | SUS316 | 0.16 |
| 33 | SUS316 | 0.16 |
| 38 | SUS316 | 0.16 |
| 43 | SUS316 | 0.16 |
| 48 | SUS316 | 0.17 |
| 53 | SUS316 | 0.17 |
| 58 | SUS316 | 0.16 |

Analysis of the cycle data illustrate that the cells show stable cell conductivity of about 0.2 mS/cm over the first 10 cycles. Due to the need to replace the current collector to stainless steel the cell conductivity measurement reduced to 0.17 mS/cm, but remained substantially constant out to 58 cycles. The reduced cell conductivity at cycles 12-58 is due to the changing collector into the stainless steel and is a simple artifact of the measurement protocol. The conductivity of the separator is understood as remaining constant throughout the measurement cycles demonstrating that the humidified perovskite oxide can maintain the same conductivity at least up to 58 cycles. The cell conductivity is the upper limit of separator conductivity. 1/cell_conductivity=1/cathode_conductivity+1/anode_conductivity+1/separator_conductivity+1/current_collector_conductivity. The conductivities of electrodes and current collector are much higher than that in the solid electrolyte. Therefore, the conductivity of cell is dominated by that of the solid electrolyte.

The overall BaCO₃ phase abundances and conductivity of all samples and controls are illustrated in Table 3.

TABLE 3

| | | | | | Weight | Conductivity |
|---|---|---|---|---|---|---|
| | | Humidification | Humidification | BaCO₃ | Gain | of cell |
| Sample | Powder | Temp (° C.) | Time (h) | wt % | (wt %) | (mS/cm) |
| Control 1 | Sample 1 | None | None | 5.3 | 0 | 0.001 |
| Example 1 | Sample 1 | 70 | 16 | 78 | 20 | 0.2 |
| Control 2 | Sample 2 | None | None | 2.6 | 0 | 0.003 |
| Example 2 | Sample 2 | 70 | 16 | 44 | 20 | 0.16 |
| Control 3 | Sample 3 | None | None | 10.5 | 0 | 0.003 |
| Example 3 | Sample 3 | 70 | 16 | 70 | 20 | 0.3 |
| Control 4 | Sample 4 | None | None | 11.5 | 0 | 0.003 |
| Example 4 | Sample 4 | 70 | 16 | 72 | 20 | 0.12 |
| Control 5 | Sample 5 | None | None | 7.3 | 0 | 0.003 |
| Example 5 | Sample 5 | 70 | 16 | 30 | 20 | 0.34 |
| Control 6 | Sample 6 | None | None | 9.2 | 0 | 0.003 |
| Example 6 | Sample 6 | 70 | 16 | 48 | 20 | 0.09 |
| Control 7 | BaCO₃ | 70 | 16 | 100 | 3 | <0.001 |

Overall, from the data presented in Table 3, humidification of the perovskite oxide materials that the BaCO₃ phase abundance, weight gain and conductivity all increase significantly relative to the identical materials without the humidification process. It is noted that the proton conductivity of the separator materials following humidification increases by greater than 100-fold. The control BaCO₃ material, however, showed very low conductivity indicating that merely the presence of BaCO₃ material is itself insufficient to produce a sufficiently proton conductive material, but that the humidification process to alter the relative phase abundances of the materials is required to produce a separator with high conductivity.

Humidification in every instance increases the BaCO₃ phase abundance of the material to greater than 20 wt % and this correlates directly with significantly improved proton conductivity. Without being limited to one particular theory, it is believed the dissociation of perovskite ABO₃ into BaCO₃ and CeO₂ is responsible for the increase in the conductivity. It may be that remaining water bonded to the surface of the fine dissociation product aids in improved proton conduction throughout the material.

The foregoing description of particular aspect(s) is merely exemplary in nature and is in no way intended to limit the scope of the invention as claimed below, its application, or uses, which may, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A proton conducting rechargeable cell comprising:
a cathode comprising a cathode active material capable of reversibly absorbing a proton;
an anode comprising an anode active material capable of reversibly absorbing a proton; and
a separator comprising an inorganic ceramic material present as a predominant in the separator, the inorganic ceramic material comprising less than 85 weight percent perovskite oxide phase and exhibiting a proton conductivity of 0.1 mS/cm or greater at 25 degrees Celsius.

2. The cell of claim 1, wherein the perovskite oxide phase is present at less than 70 weight percent, optionally less than 50 weight percent.

3. The cell of claim 1, wherein the inorganic ceramic material comprises one or more group 2 elements.

4. The cell of claim 3, wherein the one or more group 2 elements comprise Ba.

5. The cell of claim 1, wherein the separator comprises an ACO₃ phase, wherein A comprises one or more group 2 elements.

6. The cell of claim 5, wherein the ACO₃ phase is present at 20 weight percent or greater, optionally 30 weight percent or greater.

7. The cell of claim 1, wherein the separator has a weight greater than a precursor material of equal to or higher than 5 weight percent, optionally at or greater than 10 weight percent, optionally at or greater than 20 weight percent.

8. The cell of claim 1, wherein the proton conductivity is less than 23 mS/cm.

9. The cell of claim 1, wherein the inorganic ceramic material comprises an oxide, carbonate, hydroxide, or combination thereof of AZrₓY_{y}M_{z}, where A is one or combination of group 2 elements and M is one or combination of transition metals or rare earth metals, 0≤x≤0.8, 0≤y≤0.4, and 0≤z≤0.8.

10. The cell of claim 9, wherein x is 0.1 to 0.5.

11. The cell of claim 9, wherein the y is 0.1 to 0.3.

12. The cell of claim 9, wherein M is Ce and z is 0.4 to 0.8.

13. The cell of claim 9, wherein M is selected from the group consisting of La, Ce, Pr, Nd, Sm, Ti, Hf, B, Al, Ga, and combinations thereof.

14. A process of producing a proton conducting material exhibiting a proton conductivity of 0.1 mS/cm or greater at 25° C. comprising:
preparing a precursor material, the precursor material comprising one or more group 2 elements;
calcining the precursor material at a calcination temperature to form a calcined precursor material; and
subjecting said calcined precursor material to a humidification process for a treatment time and at a treatment temperature to provide a proton conducting material.

15. The process of claim 14, wherein the treatment temperature is from 70 degrees Celsius to 200 degrees Celsius.

16. The process of claim 14 wherein said subjecting comprises increasing said treatment temperature during said treatment time.

17. The process of claim 14, wherein said treatment time is 1 hour to 40 hours, optionally 10 hours to 20 hours.

18. The process of claim 14, wherein proton conducting material comprises less than 85 weight percent perovskite oxide phase and exhibits a proton conductivity of 0.1 mS/cm or greater at 25 degrees Celsius.

19. The process of claim 14, wherein the perovskite oxide phase is present at less than 70 weight percent, optionally less than 50 weight percent.

20. The process of claim 14, wherein the proton conducting material includes one or more group 2 elements, optionally wherein the one or more group 2 elements includes Ba.

21. The process of claim 14, wherein the proton conducting material comprises an ACO₃ phase, wherein A comprises one or more group 2 elements.

22. The process of claim 21, wherein the ACO₃ phase is present at 20 weight percent or greater, optionally 30 weight percent or greater.

23. The process of claim 14, wherein the proton conducting material gained weight during humidification process by at or greater than 5 weight percent, optionally at or greater than 10 weight percent, optionally at or greater than 20 weight percent.

24. The process of claim 14, wherein the conductivity is less than 23 mS/cm.

25. The process of claim 14, wherein the inorganic ceramic material comprises an oxide, carbonate, hydroxide, or combination thereof of AZrₓY_{y}M_{z}, where A is one or combination of group 2 elements and M is one or combination of transition metals or rare earth metals, 0≤x≤0.8, 0≤y≤0.4, and 0≤z≤0.8.

26. The process of claim 25, wherein x is 0.1 to 0.5.

27. The process of claim 25, wherein the y is 0.1 to 0.3.

28. The process of claim 25, wherein M is Ce and z is 0.4 to 0.8.

29. The process of claim 25, wherein M is selected from the group consisting of La, Ce, Pr, Nd, Sm, Ti, Hf, B, Al, Ga, and combinations thereof.
